(19) United States
(12) Patent Application Publication
(10) Pub. No.: US 2017/0241568 A1
(43) Pub. Date: Aug. 24, 2017

(54) PIPE REPAIR APPARATUS AND METHOD

(71) Applicant: Actuant Corporation, Menomonee Falls, WI (US)

(72) Inventor: David Barker, Staffordshire (GB)

(21) Appl. No.: 15/504,932

(22) PCT Filed: Sep. 28, 2015
(86) PCT No.: PCT/US2015/052695

§ 371 Date: Feb. 17, 2017

Related U.S. Application Data
(60) Provisional application No. 62/055,892, filed on Sep. 26, 2014.

(51) Int. Cl. F16L 1/26; F16L 55/18

(52) U.S. Cl. CPC F16L 1/265; F16L 55/18

(57) ABSTRACT

An activation frame for use by a remotely operated vehicle (ROV) to activate a subsea pipeline compression activated repair connector having no independent means of activation. The activation frame includes hydraulics and a control for the ROV to actuate the hydraulics. During installation, the hydraulics on the frame activate the pipe repair connector and form a seal between the connector and the pipe. The hydraulics, along with the frame, are separated from the connector after activation and returned to the surface.

### RELATED APPLICATION

The present application claims priority to U.S. Patent Application No. 62/055,892, filed Sep. 26, 2015, the entire contents of which are hereby incorporated by reference.

### FIELD

The present invention relates to pipeline connectors and, more particularly, to mechanical pipeline connectors for use in pipeline repairs.

### SUMMARY

When a pipe runs on a sea bottom, it is fairly common for pipe fractures to occur. When a pipe fractures, the section of damaged pipe needs to be repaired to restore service to the sub-sea pipeline. To repair the damaged pipe, the damaged section is first removed (e.g., via cutting, etc.) to make way for a new pipe section. To restore service, a new pipe section needs to be connected to the undamaged original pipe sections, for example, by a mechanical pipe connector with gripping and sealing mechanisms (e.g., a ball and taper mechanism, opposing serrated sliding wedges, etc.).

For deep-water pipeline repairs, connectors with integrated hydraulics are often used to grip the existing pipeline subsea and form a seal with newly installed pipe. One example of such a connector is shown and described in U.S. Patent Application Publication No. US 2010/0047023 A1, published Feb. 25, 2010, the contents of which are hereby incorporated by reference.

During deep-water pipeline repair, as discussed in U.S. Patent Application Publication No. US 2010/0047023, an installation frame is typically used to lower and properly position the connector. When properly positioned, a remotely operated vehicle (ROV) stabs into the connector to actuate the integrated hydraulics to attach and seal the connector to the pipe. The installation frame is ultimately detached from the connector and returned to the surface.

These existing mechanical pipe connectors are relatively expensive due to the incorporation of the hydraulic cylinders and controls that remain with the connector on the sea bottom after activation.

In one independent aspect, a pipe connector and frame may be provided for connecting pipes, and hydraulic cylinders and controls may generally be included on the frame. During installation, the hydraulics on the frame activate the pipe connector, forming a seal between the connector and the pipe. The hydraulics, along with the frame, are returned to the surface after activation.

In another independent aspect, a subsea pipeline repair system may generally include a frame having at least one hydraulic cylinder and a connector selectively coupled to the frame. The connector has compression activated sealing members for forming a seal with a pipeline needing repair. The connector has a first state, in which the sealing members are not in a sealed position with respect to the pipeline, and a second state, in which the sealing members are moved to a sealed state via application of a compressive force by the hydraulic cylinder. During repair of the pipeline, the frame and connector are coupled together during installation of the connector on the pipeline, and a remotely operated vehicle interfaces with the frame to actuate the hydraulic cylinder which then compresses the sealing members of the connector into sealing engagement with the pipeline. Upon complete installation of the connector, the frame and hydraulic cylinder disconnect from the connector.

In a further independent aspect, a method of remotely installing a connector on a pipeline using a remotely operated vehicle may be provided. The method may generally include providing a connector requiring actuation of sealing members from a first position to a second position to form a sealing engagement with the pipeline, the connector having no independent actuation means, and providing an activation frame having hydraulics and controls for installing and activating the connector. The method may further include coupling the connector to the actuation frame, lowering the connector and actuation frame from a surface to the pipeline, positioning the connector and actuation frame along the pipeline, actuating the hydraulics on the frame with the remotely operated vehicle, moving the sealing members in the connector from the first position to the second position with the hydraulics of the frame to form a sealing engagement between the connector and the pipeline, disconnecting the frame from the connector, and returning the frame with the hydraulics to the surface.

In a further independent aspect, an activation frame for use by a remotely operated vehicle to activate a subsea pipeline repair connector may be provided. The repair connector may be a compression activated type connector having an outer sleeve defining a cavity and an inner sleeve received within the cavity, movement of the inner sleeve relative to the outer sleeve forcing the sealing members into sealing engagement with the pipeline. The activation frame may generally include a support, a bracket connected to the support, and a hydraulic cylinder coupled to the bracket and slidably supported by the support to engage and selectively move the inner sleeve relative to the outer sleeve of the connector to compress sealing members within the cavity of the connector.

Other independent features and independent advantages of the invention may become apparent to those skilled in the art upon review of the detailed description, claims and drawings.

### BRIEF DESCRIPTION OF DRAWINGS

FIG. 1 is a cross-sectional view of a pipe connector for use in a pipeline repair system.

FIGS. 2A-2B are cross-sectional views of a portion from the pipe connector shown in FIG. 1 and illustrating radial plungers being moved by axially movement of ramp rings.

FIGS. 3A-3C are cross-sectional views of a portion from the pipe connector shown in FIG. 1 and illustrating the radial plungers in combination with round and out-of-round pipes.

FIGS. 4A-4D are cross-sectional views of the pipe connector shown in FIG. 1 and illustrating installation of the pipe connector.

FIGS. 5A-5B are perspective views of two split rings used in the pipe connector of FIG. 1.

FIG. 6A is a cross-sectional view of a portion from the pipe connector shown in FIG. 1 and illustrating installation of the inner sleeve into the outer sleeve.

FIG. 6B is a perspective view of the inner sleeve shown in FIG. 6A.

FIG. 7 is a cross-sectional view of a portion from the pipe connector of FIG. 1 illustrating how one or more shims prevents the inner sleeve from moving further axially inward prior to final installation.

FIG. 8 is an enlarged view of a portion of the pipe connector shown in FIG. 1 and illustrating the split ring prior to being received in a ring groove.

FIGS. 9A-9C are cross-sectional views of a portion from the pipe connector shown in FIG. 1 and illustrating movement of the inner sleeve relative to the outer sleeve to deploy the split ring into the ring groove.

FIG. 10 is an enlarged view of a portion of the pipe connector shown in FIG. 1 and illustrating the split ring after the split ring is received in the ring groove.

FIG. 11A is a perspective view of an activation frame used to install the pipe connector of FIG. 1.

FIG. 11B is a perspective view of a remotely operated vehicle (ROV) with the activation frame in FIG. 11A.

FIG. 12 is a top perspective view of the activation frame end hydraulic cylinders, platens, and alignment brackets.

FIG. 13 is a bottom perspective view of the activation frame end hydraulic cylinders, platens, and alignment brackets.

FIGS. 14A-14C are side views of the activation frame being removed from the pipe connector of FIG. 1

FIGS. 15A-15B are side views illustrating deep water pipe laying methods.

FIG. 15C is a perspective view of a survey machine for surveying a pipe line.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

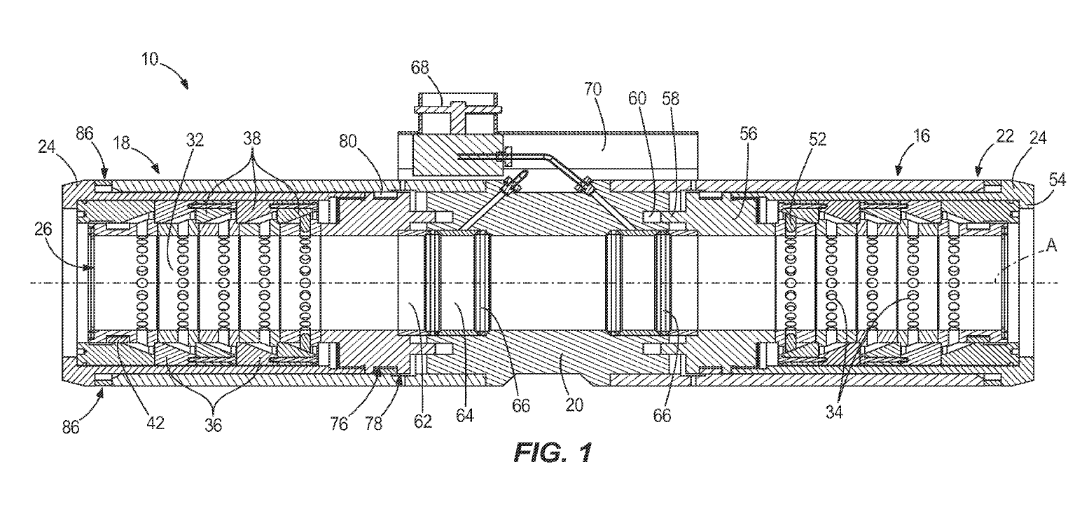

FIG. 1 illustrates a pipe connector 10 in accordance with an independent embodiment of the invention. The illustrated connector 10 is substantially symmetric about a center vertical axis, with respect to FIG. 1, and any feature or element referenced on one side of the connector 10 equally pertains to the mirrored feature or elements on the other side of the connector 10.

As an example, the connector 10 may be used in the repair of pipelines and may receive the ends of two pipes 12, 14 to be connected together. The connector 10 is configured to grip onto and fluidly couple the first pipe 12 and the second pipe 14 in the pipeline to be repaired.

The pipe connector 10 defines a longitudinal axis A and a cavity. The connector 10 includes an outer sleeve 16 with a first end 18, a central portion 20, and a second end 22, and each end 18, 22 slidably receives an inner sleeve 24 along the axis A. The inner sleeves 16 move axially inwardly and outwardly with respect to the outer sleeve 12 for compressing various components held within the cavity. The outer sleeve 16, the inner sleeves 24, and other components of the connector 10 each define a cylindrical opening or bore 26 for receiving the end of at least one of the pipes 12, 14.

In the illustrated construction, the central portion 20, which receives the ends of the pipes 12, 14, is formed separately from the first end 18 and the second end 22 of the outer sleeve 16. In other constructions (not shown), the central portion may be formed with the first end 18 and the second end 22 to form the outer sleeve 16 as a singled piece.

An inner race 32 is received within but spaced apart from each inner sleeve 24 and coaxial with axis A. Each inner race 32 has a plurality of spaced apart openings 34 distributed uniformly about the circumference and arranged in one or more axially-spaced rows. A number of ramp rings 36, including annular ramps 38 (corresponding to the number of rows), are located adjacent to one another and slidably received radially between the inner race 32 and the inner sleeve 24. Each ramp 38 is positioned to radially align with a row of openings 34 in the inner race 32. The ramp ring 36 nearest the end of the inner sleeve 24 is pushed into engagement against the inner sleeve 24 by a radially expanding inner race locking ring 42.

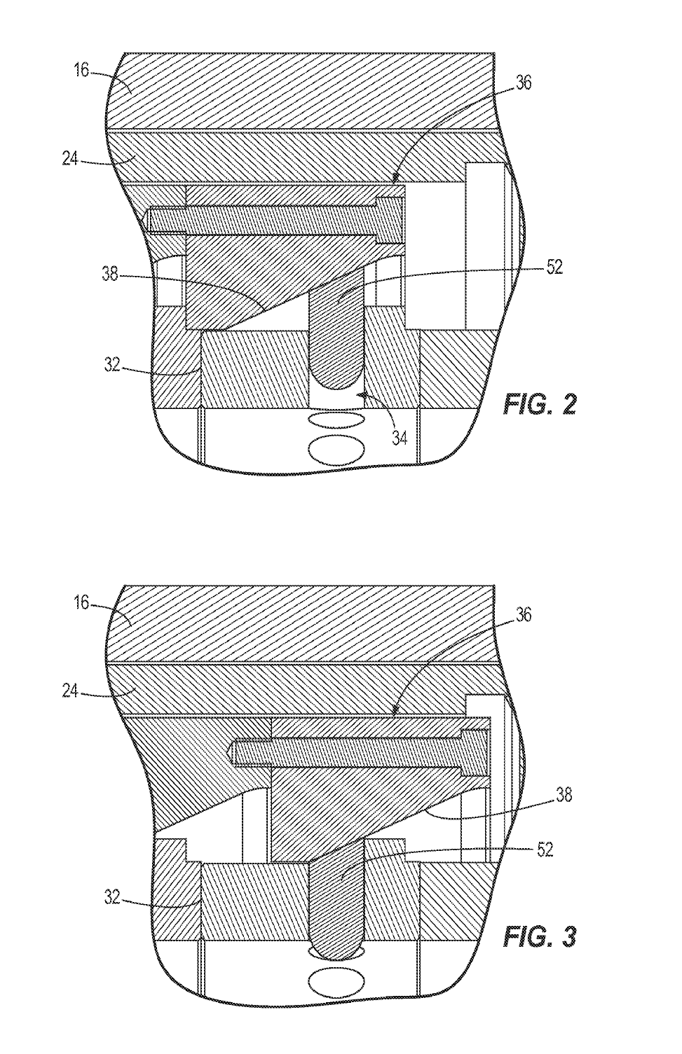

A radially-activated plunger or indent pin 52 is slidably secured in each of the openings 34 and located adjacent a ramp 38 on a respective ramp ring 36. As illustrated in FIGS. 2A and 2B, when the ramp ring 36 slides axially inwardly relative to the inner race 32, the angled surfaces of the ramps 38 push the indent pins 52 radially inwardly so that the end of each pin 52 engages with the outer surface of one of the pipes 12, 14 to hold the connector 10 in place. In the illustrated constructions, the pins 52 indent the outer surface of the pipe 12, 14. The ramp rings 36 also function to hold the indent pins 52 in their respective openings 34. Radial activation of the indent pins 52, limits or removes the need for hard abutment of the end of the pipe 12, 14 and the close tolerance of pipe insertion. In the illustrated construction, there are five rows of indent pins 52.

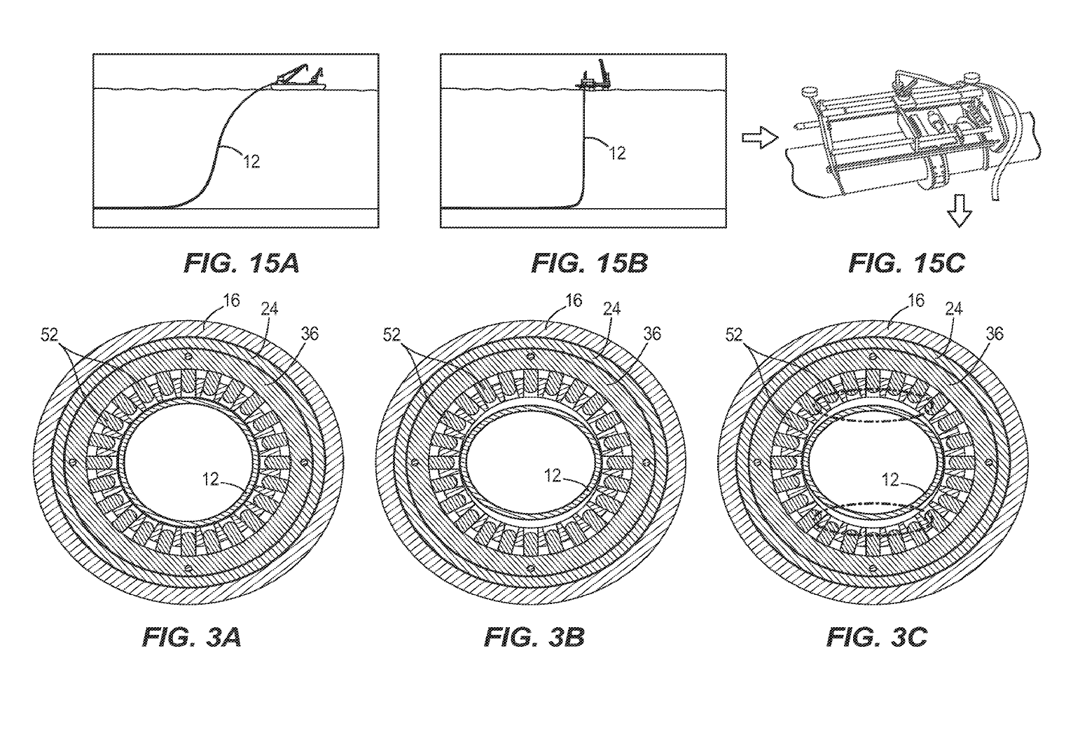

In some constructions, the indent pins 52 may be profiled (e.g., etched, grooved, serrated, etc. at least on the engaging end) to resist decoupling of the connector 10 and pipes 12, 14. In some applications, different length pins 52 may be used for contacting out-of-round pipes (FIGS. 3B and 3C), as explained below. When round pipes are used in the connector 10, all of the indent pins 52 will contact the pipe at the same time when activated, for 100% capacity.

Pipe can be damaged by, for example, deep water pipe laying methods shown in FIGS. 15A-15B, which may cause pipe to buckle, and, when damaged, the pipe may be oval or out-of-round. When pipe is oval or out-of-round, when activated, all of the indent pins 52 will not contact the pipe at the same time, resulting in less than 100% capacity. An oval or out-of-round pipe may thus, require different length pins 52. A survey of the pipeline to be repaired, shown in FIG. 15C, may be used to determine whether and to what extent a pipe is out-of-round. Based on that determination, pins 52 of appropriate length may be selected and used in the connector 10 to regain holding capacity.

The inner sleeve 24 has a reduced diameter at its end, formed by a radially inward extending flange 54. The flange 54 abuts an adjacent ramp ring 36, holding the ramp rings 36 between the inner race 32 and the inner sleeve 24. In the illustrated construction, the flange 54, however, only partially covers the ramp ring 36 at the end of the connector 10, allowing a mechanism or activation unit to access the ramp rings 36, as further explained below.

A spacer 56, sometimes called a seal and indent pin spacer, is received within the outer sleeve 16, axially between the end of the inner sleeve 24 and the central portion 20. The spacer 56 is held in against the inner end of the inner sleeve 24 and moves axially inwardly when the inner sleeve 24 is also moved axially inwardly. The spacer 56 has an annular, axially-extending protrusion 58 received within an annular, axially-extending groove 60 in the central portion 20, guiding relative movement of the spacer 54 and the central portion 20.

A replaceable annular seal insert 62 and a seal insert spacer 64 are located between the spacer 54 and the central portion 20 and compress therebetween an expandable seal 66. Another seal 66 is located on the other side of the seal insert spacer 64 to also be compressed. When the inner sleeves 24 and the spacers 56 move axially inwardly (i.e., toward the central portion 20), the material of the seals 66 compresses between the spacer 56 and the central portion 20. Compression of the seals 66 causes them to radially expand to engage the inner surface of the central portion 20 and the outer surface of the pipe(s) 12, 14.

The illustrated seals 66 may be of the type used in the commercially available line of engineered mechanical subsea connectors manufactured by Hydratight Limited. The seal 66 may be, for example, 98% pure exfoliated graphite. The seals 66 may include a laminate graphite sheet and/or be ribbon spun or spiral-wound around a mandrel into a mold that can be subsequently manipulated into a suitable construction (e.g., size, shape, etc.) for the connector 10. In other constructions, the seal 66 may include any of a variety of other seal packing materials.

One or more anti-extrusion rings may prevent the seals 66 from extruding into gaps between the pipes 12, 14 and adjacent components of the connector 10 during compression. The anti-extrusion rings can close down onto (i.e., move radially inwardly with respect to) the pipes 12, 14.

An isolating valve 68, assembled as part of a connector cover 70, is used with a fluid line (e.g., air) to test the space between the seals 66 to insure the seals 66 have activated properly to create an fluid-tight pressurized seal. To confirm that the connector 10 has been installed correctly, the space between each seal 66, at each end of the connector 10, can be accessed by the isolating valve 68 and pressurized to a desired hydraulic pressure. The hydraulic pressure is held for an appropriate length of time to confirm seal integrity of the connector 10.

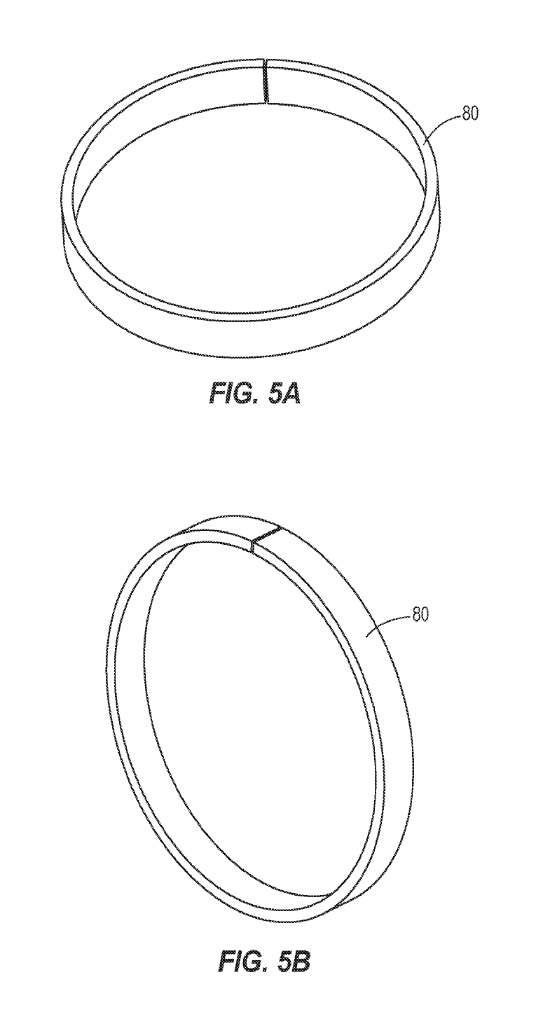

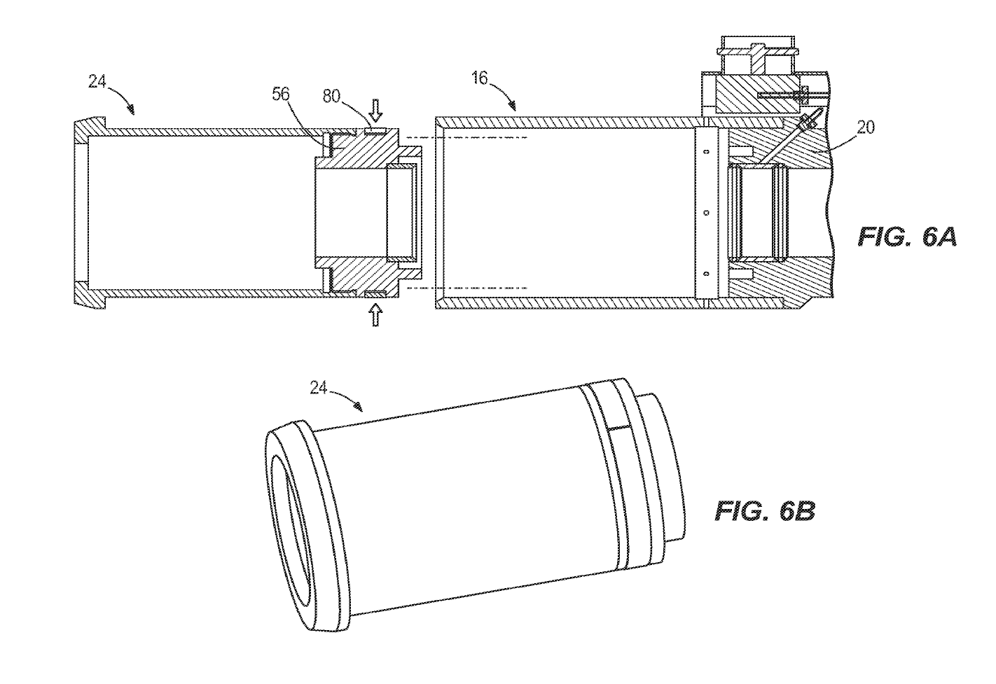

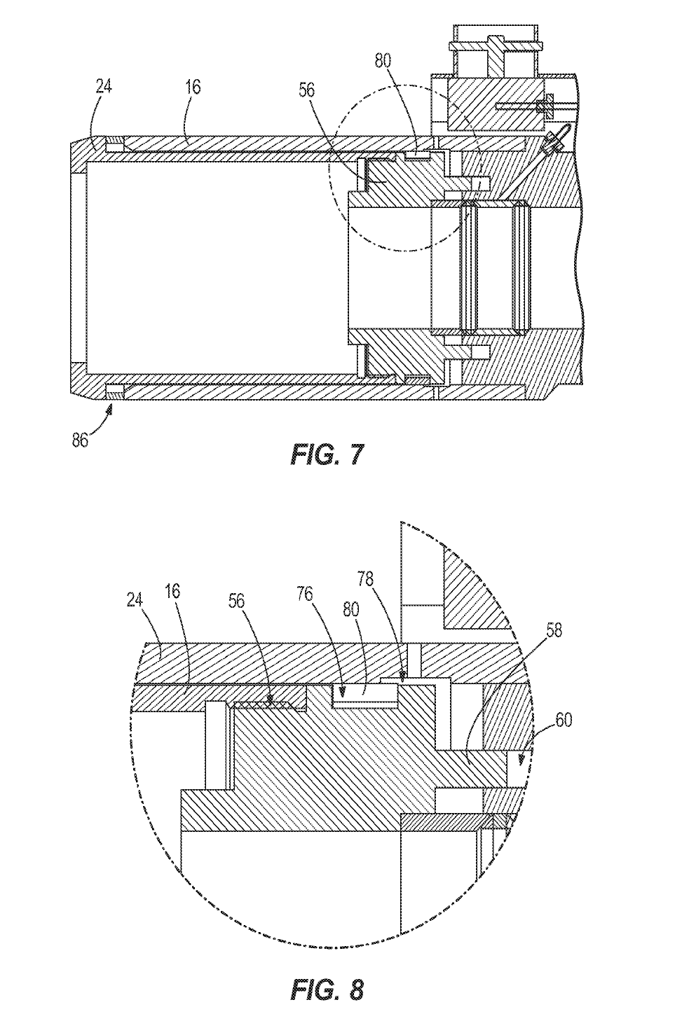

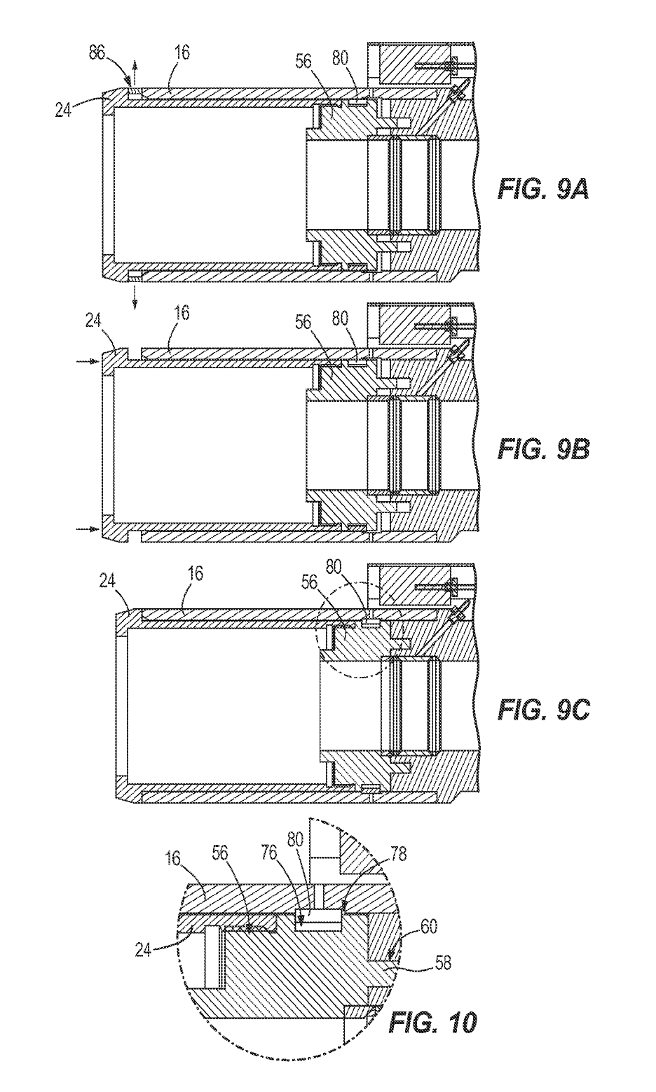

The spacer 56 also defines an annular ring slot 76 adjacent to an annular ring receiving groove 78 formed in the outer sleeve 16, as illustrated in FIGS. 9A-10. A split ring 80 (see FIGS. 5A-5B) is received in the annular ring slot 76 of the spacer 56 (FIGS. 6A-8). When the connector 10 is activated, the split ring 80 is expandable radially outward into the ring receiving groove 78 when the inner sleeve 24 moves axially inwardly towards the center of the connector 10 to a position where the ring slot 76 and the ring receiving groove 78 of the outer sleeve 16 are aligned (FIGS. 9C and 10). This engagement serves to lock the inner sleeve 24 within the outer sleeve 16, thus, locking the inner sleeve 24 in place preventing loss of seal compression. The split ring 80, when radially expanded outwardly, also provides a means of locking in place all the components, thus acting as a load retaining structure or providing a load retaining method.

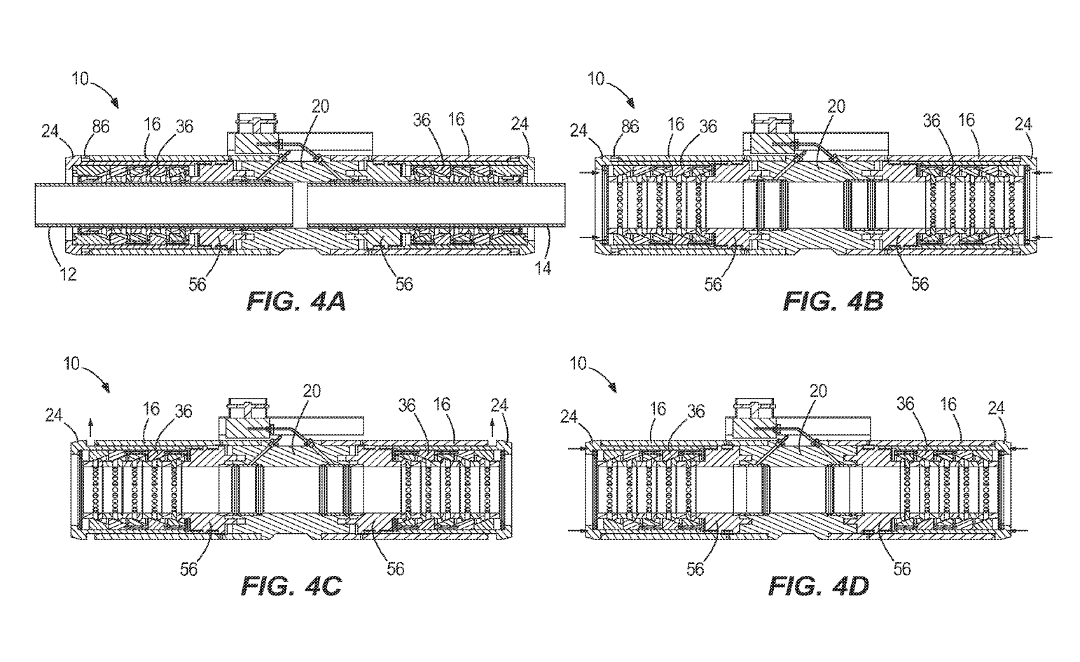

During the assembly, installation, and activation process, the split ring 80 is compressed, and the inner sleeve 24 and assembled spacer 54 and split ring 80 are slid into the outer sleeve 16 of the connector 10, as illustrated in FIGS. 6A-8. FIG. 1 illustrates the connector 10 in a condition for installation onto the pipes 12, 14, (i.e., aligned on pipes 12, 14 and ready for activation). After the connector 10 is installed on the pipes 12, 14 (FIG. 4A), the connector 10 is then activated by an activation system 102 to grip onto the pipes 12, 14 with the indent pins 52 and to activate the seals 66 (FIGS. 4B-4D). The illustrated split ring 80 is manufactured from high tensile steel (e.g., Inconel 625 or 718), due to high component compressive stresses present when the connector 10 is assembled.

The illustrated activation system 102, further explained below, accesses the ramp rings 36 at the end of the connector 10 in order to move the ramp rings 36 towards the center portion 20 (FIG. 4B). More specifically, the activation system 102 pushes the ramp rings 36 axially inwardly along the inner race 32, thereby causing the ramps 38 to push the indent pins 52 radially inwardly towards the pipes 12, 14 to grip and secure the pipe ends inside the connector 10, as shown in FIGS. 2A and 2B.

Thereafter, a shim 86, which normally spaces the inner sleeve 24 from the end of the outer sleeve 16 by a shim gap and prevents the inner sleeve 24 from prematurely moving during final operation, is removed (FIG. 4C). The inner sleeve 24 is then moved axially inwardly relative to the outer sleeve 16 (i.e., towards the central section 20), closing the shim gap and compressing the seals 66. This movement of the inner sleeve 24 causes the expandable seals 66 to expand (FIG. 4D). In addition, the split ring 80 expands and locks into the groove 78. In the inward position, the inner sleeve 24 holds the ramp rings 36 in place. In one example, movement of the inner sleeve 24 relative to the outer sleeve 16 can, in one motion, push the ramp rings 36 along the inner race 32, inserting the indent pins 52, and compress the spaced apart seals 66.

As illustrated in FIGS. 3A-3C, it is not uncommon for the portion of pipe to be repaired to be out-of-round or, in other words, more ovular in shape. The length of indent pins 52 can be selected for different portions of the connector 10, to provide a more secure engagement between the connector 10 and the pipes 12, 14. For example, the portion (FIG. 3C) of the connector 10 spaced farther from the out-of-round pipe 12 than in a normal round pipe 12 (FIG. 3A) can utilize one or more longer pins 52 to span the gap to engage and securely grip onto the outer surface of the out-of-round pipe 12.

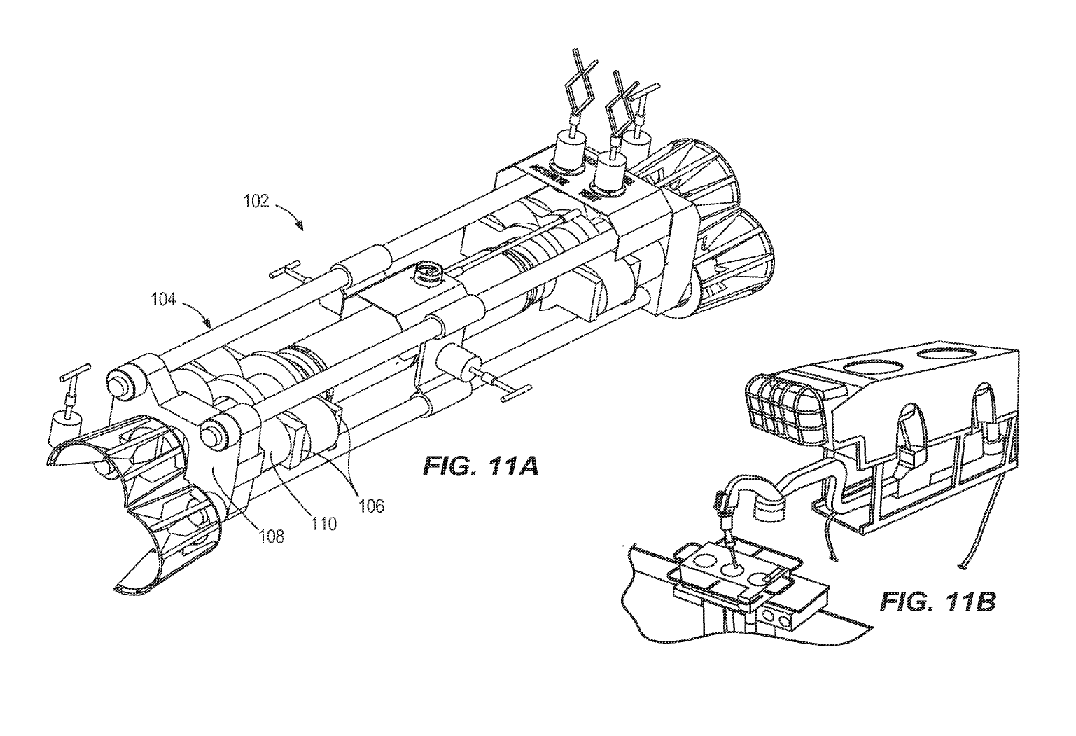

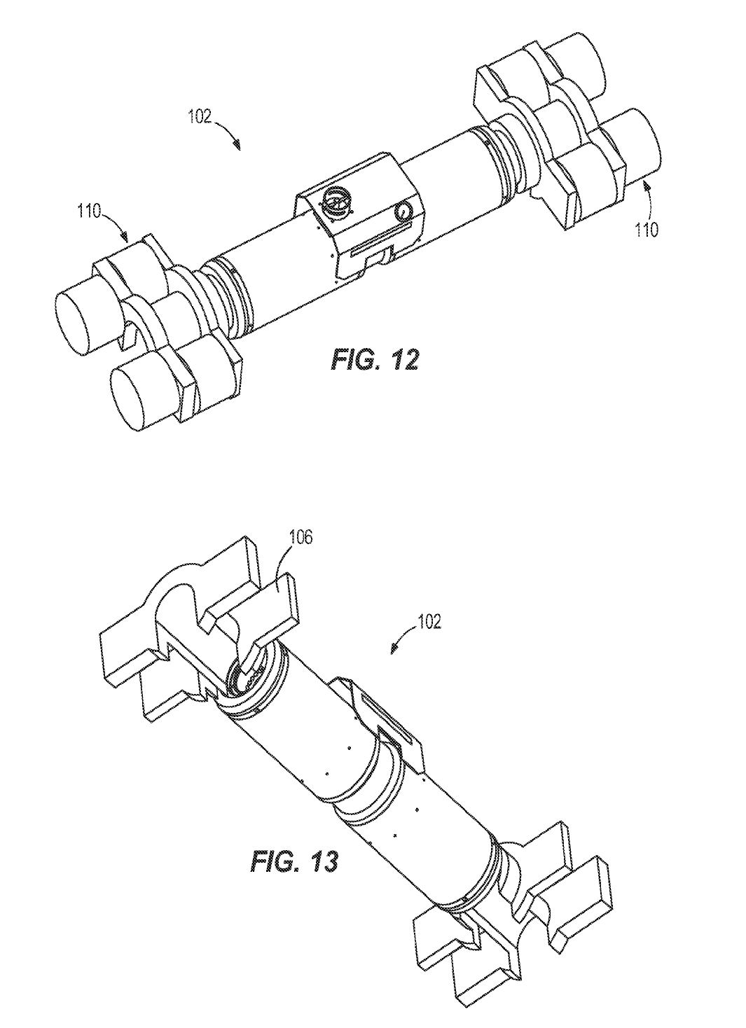

To connect the connector 10 to the pipes 12, 14, the activation frame 10 (FIGS. 11A-11B) is used. In general terms, the frame 102 is a simple hydraulic press mechanism with the means to be operated under the water. The illustrated frame 102 is operated using an underwater Remotely Operated Vehicle (ROV) (shown in FIG. 11B) such that there is no physical installation or operation from the surface. The frame 10 includes ROV stab-in connection points such that a working-class ROV can simply stab into the frame 102 to carry out the functions of installation. The frame 102 is simply stored and ready for rapid response.

The activation frame 102 includes a support 104 and a horseshoe-shaped platen 106 at each support end. A bracket 108 is connected to each support end, and a pair of hydraulic cylinders 110 (e.g., an inner ram and an outer ram) is supported by each bracket 108. One end of each hydraulic cylinder 110 is secured to the bracket 108, and the other end of each hydraulic cylinder 110 is slidably supported by the support 104. The horseshoe-shaped platens 106 can be used to align the frame to the pipe. The horseshoe-shaped platens 106 include slots to allow assembly and disassembly on the pipe. The frame 102 further includes “buckets” or guide cones for aligning the frame 102 to the pipe.

Extension of the cylinders 110 moves the platen 106 toward the central portion 20 of the outer sleeve 16, in turn moving the ramp rings 36, and the inner sleeves 24 axially inwardly. As discussed above, movement of the ramp rings 36 causes the ramps 38 to push the indent pins 52 radially inwardly towards the pipes 12, 14 to grip and secure the pipe ends inside the connector 10, as shown in FIGS. 2A and 2B. As also discussed above, movement of the inner sleeve 24 relative to the outer sleeve 16 can, in one motion, push the ramp rings 36 along the inner race 32, inserting the indent pins 52, and compress the spaced apart seals 66.

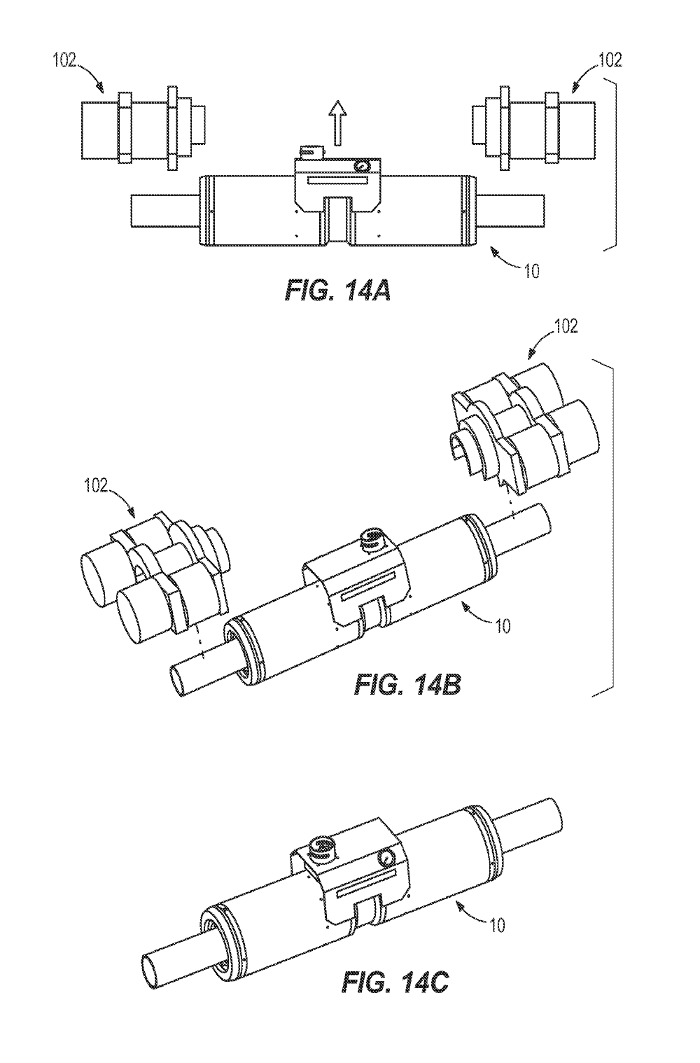

The activation frame 102 is intended to house all (or substantially all) the hydraulics and controls necessary for installation of the connector 10. After installation is completed, the activation frame 102 is disconnected, leaving only the connector 10 on the pipes 12, 14 (FIGS. 14A-14C). In other words, after activation, all connections between the frame 102 and the connector 10 are removed by the ROV. Thus, in some constructions, the frame 102 is disconnected from the connector 10, leaving only the connector 10 on the pipe. The frame 102, along with the hydraulics, is then lifted away for use with another connector. The frame 102 may be mounted into a larger frame, which may be bespoke, specific to the repair application.

The components of the connector 10 are compatible with the material of the pipeline and with the media carried by the pipeline. In some constructions, the structural components may be formed of suitable materials, such as, for example, steel, stainless steel, carbon steel, etc.

Although the invention has been described in detail with reference to certain preferred embodiments, variations and modifications exist within the scope and spirit of one or more independent aspects of the invention as described above.

One or more independent features and/or independent advantages of the invention may be set forth in the following claims.

What is claimed is:

1. A subsea pipeline repair system comprising:
a frame having at least one hydraulic cylinder; and
a connector selectively coupled to the frame, the connector having compression activated sealing members for forming a seal with a pipeline needing repair, the connector having a first state, in which the sealing members are not in a sealed position with respect to the pipeline, and a second state in which, the sealing members are moved to a sealed state via application of a compressive force by the hydraulic cylinder;
wherein, during repair of the pipeline, the frame and connector are coupled together during installation of the connector on the pipeline, and a remotely operated vehicle interfaces with the frame to actuate the hydraulic cylinder which then compresses the sealing members of the connector into sealing engagement with the pipeline; and
wherein, upon complete installation of the connector, the frame and the hydraulic cylinder disconnect from the connector.

2. The system of claim 1, wherein the connector further includes
an outer sleeve defining a cavity and extending along a longitudinal axis, and
an inner sleeve received within the cavity,
wherein movement of the inner sleeve relative to the outer sleeve caused by the hydraulic cylinder forces the sealing members into sealing engagement with the pipeline.

3. The system of claim 2, wherein the connector further includes
an inner race received within the inner sleeve and defining a plurality of radial openings,
a ramp received between the inner race and the inner sleeve for sliding movement along the longitudinal axis, and
a plurality of indent pins, each indent pin being slidably secured in an associated one of the plurality of openings and being engageable by the ramp, sliding movement of the ramp causing radially inward movement of the plurality of indent pins to engage an outer surface of the pipeline.

4. The system of claim 1, wherein the frame further includes controls for interfacing with a remotely operated vehicle to allow installation functions to be carried out.

5. The system of claim 1, wherein the connector has a first end and a second end, the sealing members activated on the first end being first sealing members and the sealing members activated on the second end being second sealing members; and
wherein the frame further includes
a support,
a first bracket connected to a first end of the support and a second bracket connected to a second end of the support, and
a first hydraulic cylinder coupled to the first bracket and slidably supported by the support to engage and selectively compress the first end of the connector and a second hydraulic cylinder coupled to the second bracket and slidably supported by the support to engage and selectively compress the second end of the connector.

6. The system of claim 5, wherein the frame further includes a first platen coupled to the support adjacent the first end of the connector and a second platen coupled to the support adjacent the second end of the connector, the first platen and the second platen being positioned between the hydraulic cylinders and the end of the connector to deliver force from the hydraulic cylinders to the respective ends of the connector.

7. A method of remotely installing a connector on a pipeline using a remotely operated vehicle, the method comprising:
providing a connector requiring actuation of sealing members from a first position to a second position to form a sealing engagement with the pipeline, the connector having no independent actuation means;
providing an activation frame having hydraulics and controls for installing and activating the connector;
coupling the connector to the actuation frame;
lowering the connector and actuation frame from a surface to the pipeline;
positioning the connector and actuation frame along the pipeline;
actuating the hydraulics on the frame with the remotely operated vehicle;
moving the sealing members in the connector from the first position to the second position with the hydraulics of the frame to form a sealing engagement between the connector and the pipeline;
disconnecting the frame from the connector; and
returning the frame with the hydraulics to the surface.

8. The method of claim 7, wherein the hydraulics are hydraulic cylinders, and wherein moving the sealing members further includes applying a compressive force on the connector with the hydraulic cylinders.

9. The method of claim 8, wherein the connector includes an outer sleeve defining a cavity and extending along a longitudinal axis, an inner sleeve received within the cavity, and wherein applying a compressive force further includes moving the inner sleeve relative to the outer sleeve and forcing the sealing members into sealing engagement with the pipeline.

10. The method of claim 7, wherein the activation frame includes controls, and wherein actuating the hydraulics further includes stabbing into the activation frame with the remotely operated vehicle to operate the controls on the frame.

11. The method of claim 7, wherein moving the sealing members further includes compressing spaced apart seals into engagement with the pipeline.

12. An activation frame for use by a remotely operated vehicle to activate a subsea pipeline compression activated repair connector, the connector having an outer sleeve defining a cavity and an inner sleeve received within the cavity, movement of the inner sleeve relative to the outer sleeve forcing the sealing members into sealing engagement with the pipeline, the activation frame comprising:
a support;
a bracket connected to the support; and
a hydraulic cylinder coupled to the bracket and slidably supported by the support to engage and selectively move the inner sleeve relative to the outer sleeve of the connector to compress sealing members within the cavity of the connector.

13. The activation frame of claim 12, wherein the frame further comprises a platen coupled to the support and positioned between the hydraulic cylinder and an end of the connector to deliver force from the hydraulic cylinders to the end of the connector.

14. The activation frame of claim 12, wherein the bracket is a first bracket connected to a first end of the support, and wherein the hydraulic cylinder is a first hydraulic cylinder coupled to the first bracket, and wherein the frame further comprises:
a second bracket coupled to a second end of the support; and
a second hydraulic cylinder coupled to the second bracket and slidably supported by the support to engage and selectively move the inner sleeve of the connector relative to the outer sleeve of the connector to compress sealing members within the cavity of the connector.

15. The activation frame of claim 14, wherein the platen is a first platen positioned between the first hydraulic cylinder and an end of the connector, and wherein the frame further comprises a second platen coupled to the support and positioned between the second hydraulic cylinder and an end of the connector opposite the end engaged by the first hydraulic cylinder.

16. The activation frame of claim 15, further comprising:
a third hydraulic cylinder adjacent the first hydraulic cylinder and engaging the first platen; and
a fourth hydraulic cylinder adjacent the second hydraulic cylinder and engaging the second platen.

17. The activation frame of claim 16, further comprising a control for manipulation by the remotely operated vehicle.
